(19) United States
(12) Patent Application Publication
(10) Pub. No.: US 2006/0070026 A1
(43) Pub. Date: Mar. 30, 2006

(54) Document creation system and related methods

(76) Inventors: Helen Balinsky, Cardiff (GB); Maurizio Pllu, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/217,158

(22) Filed: Sep. 1, 2005

(30) Foreign Application Priority Data
Sep. 2, 2004 (GB) 0419456.9

(51) Int. Cl. G06F 9/44

(52) U.S. Cl. 717/106; 717/110

(57) ABSTRACT

One embodiment of a method of creating a document involves the following steps, generate a draft document and create a saliency map therefrom which rates regions of the draft document according to the saliency of that region, perform a comparison of the saliency of one or more predetermined regions against a relevancy rating for that region and alters one or more document parameters associated with the draft document if the comparison shows that one or more of the predetermined regions has a saliency that does not match that required by the relevancy data for that region. Other methods and systems are also provided.

### CLAIM TO PRIORITY

This application claims priority to copending United Kingdom utility application entitled, “Document Creation System and Related Methods,” having serial no. GB 0419456.9, filed Sep. 2, 2004, which is entirely incorporated herein by reference.

### TECHNICAL FIELD

The present disclosure is generally related to a document creation system and related methods. In particular, but not exclusively, the present disclosure relates to customisation of printed documents.

### BACKGROUND

It is appreciated that sales literature, for example a brochure or an advertising flyer, targeted at individual customers, which is personalised to target the customers interests, business, purchasing habits, etc., is likely to result in more sales per literature item. However, to produce a personalised item of sales literature for each customer increases the costs associated with the literature as well as the time required to produce it. It will be further appreciated that, in addition to the information displayed, a successful sales literature item will also be well presented, appearing attractive and interesting to the customer in order to gain their attention. Design ‘rules’ as to what is considered attractive are well understood by those in the art. They include proportions (such as the ‘ideal’ proportions of Da Vinci's Vitruvian Man), balance in colour and/or spread of focus points, choice of colour and so on.

It is broadly accepted that the natural focus point for a page is generally 2/7^{th} of the way down the page at the centre (this tends to be where the photograph on the front page of a newspaper is placed). However, it will be appreciated that on occasion, it may be desired to ‘break’ a rule to create a particular effect on a viewer-posters designed to shock the viewer often have their focus point in one corner.

In an item of sales literature, it is also desirable that important items be emphasised. This adds to the time and work required to produce each sales literature item.

### SUMMARY

According to a first aspect of the present disclosure, there is provided one embodiment of a method of creating a document comprising using a processing means to perform the following steps:
i. generate a draft document and create a saliency map therefrom which rates regions of the draft document according to the saliency of that region;
ii. perform a comparison of the saliency of one or more predetermined regions against a relevancy rating for that region; and
iii. altering one or more document parameters associated with the draft document if the comparison shows that one or more of the predetermined regions has a saliency that does not match that required by the relevancy data for that region.

The predetermined characteristics may for example comprise the position or data associated with the emphasised point. The predetermined criteria may comprise the desired degree of emphasis for the emphasised point.

According to a second aspect of the present disclosure, there is provided a document creation system comprising a saliency mapping means arranged to receive an electronic version of a document displaying content and to determine salient regions of the document, a saliency rating means arranged to give a rating of the document according to the salient regions determined by the saliency mapping means and a document adjustment means arranged to adjust the content of a document, to generate an adjusted document in which the rating given by the saliency rating means more closely matches a predetermined desired rating.

The document adjustment means may be arranged to adjust the document to improve the conformity of one or more of the or each salient region with the predetermined criteria. This may be advantageous as a suitable document may be achieved with less iteration.

According to a third aspect of the present disclosure, there is provided a machine readable medium containing instructions to cause a computer to perform the method of the first aspect of the disclosure.

According to a fourth aspect of the present disclosure, there is provided a machine readable medium containing instructions to cause a computer to act as the system of the second aspect of the present disclosure.

The machine readable medium of the third or fourth aspects of the present disclosure may be any one or more of the following: a floppy disk; a CDROM/RAM;

a DVD ROM/RAM (including +R/RW, −R/RW); any form of magneto optical disk; a hard drive; a memory; a transmitted signal (including an internet download, file transfer, or the like); a wire; or any other form of medium.

The skilled person will appreciate that any of the features discussed in relation to any of the above aspects of the present disclosure may equally be applied to any of the other aspects of the disclosure.

### BRIEF DESCRIPTION OF THE DRAWINGS

An embodiment of the present disclosure is now described, by way of example only and with reference to the accompanying figures of which:

FIG. 1 shows a computer system arranged to provide one embodiment of the present disclosure;

FIG. 2 shows detail of the memory of the computer system of FIG. 1;

FIG. 3 shows a flowchart outlining the steps in carrying out one embodiment of the present disclosure;

FIG. 4 shows an example template for an item of sales literature;

FIGS. 5 to 7 show details added to the template in carrying out the method of FIG. 3;

FIG. 6a shows an example of a saliency map which may be produced from the item of sales literature shown in FIG. 6;

FIG. 7a shows an example of a saliency map which may be produced from the item of sales literature shown in FIG. 7;

FIG. 8 shows a flowchart providing detail of one of the steps of FIG. 3;

FIG. 9 shows an example of a page displaying text and graphics; and

FIG. 10 shows an example of a saliency map created from the page of FIG. 9 using an embodiment of the disclosure.

### DETAILED DESCRIPTION

FIG. 1 shows a computer 100 arranged to accept data and to process that data. The computer 100 comprises a display means 102, in this case a Cathode Ray Tube (CRT) display, a keyboard 104, a mouse 106 and processing circuitry 108. It will be appreciated that other display means such as LEP (Light Emitting Polymer), LCD (liquid crystal display), projectors, televisions and the like may be equally possible.

The processing circuitry 108 comprises a processing means 110, a hard drive 112 (containing a store of data), memory 114 (RAM and ROM), an I/O subsystem 116 and a display driver 117 which all communicate with one another, as is known in the art, via a system bus 118. The processing means 110, often referred to as a processor) typically comprises at least one INTEL™ PENTIUM™ series processor, (although it is of course possible for other processors to be used) and performs calculations on data. The other processors may include processors such as the AMD™ ATHLON™, POWERPC™, DIGITAL™ ALPHA™, and the like.

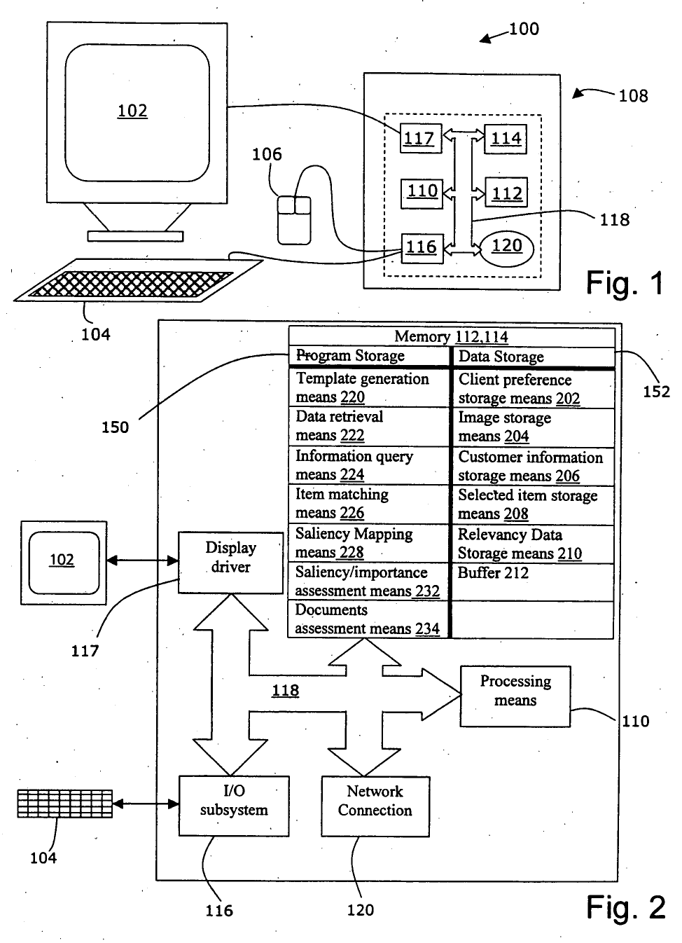

The hard drive 112 is used as mass storage for programs and other data. The memory 114 is described in greater detail below and with reference to FIG. 2.

The keyboard 104 and the mouse 106 provide input means to the processing means 110. Other devices such as CDROMS, DVD ROMS, scanners, etc. could be coupled to the system bus 118 and allow for storage of data, communication with other computers over a network, etc. Any such devices may then comprise further input means.

The I/O (Input/Output) subsystem 116 is arranged to receive inputs from the keyboard 104 and from the processing means 110 and may allow communication from other external and/or internal devices. The display driver 117 allows the processing means 110 to display information on the display 102.

The processing circuitry 108 further comprises a transmitting/receiving means 120, which is arranged to allow the processing circuitry 108 to communicate with a network. The transmitting/receiving means 120 also communicates with the processing circuitry 108 via the bus 118.

The processing circuitry 108 could have the architecture known as a PC, originally based on the IBM™ specification, but could equally have other architectures. The processing circuitry 108 may be an APPLE™, or may be a RISC system, and may run a variety of operating systems (perhaps HP-UX, LINUX, UNIX, MICROSOFT™ NT, AIX™, or the like). The processing circuitry 108 may also be provided by devices such as Personal Digital Assistants (PDA's), mainframes, telephones, televisions, watches or the like.

FIG. 2 shows the memory 114 of the computer 100 of FIG. 1 in greater detail. It will be appreciated that although reference is made to a memory 114 it is possible that the memory could be provided by a variety of devices. For example, the memory may be provided by a cache memory, a RAM memory, a local mass storage device such as the hard disk 112, any of these connected to the processing circuitry 108 over a network connection such as via the transmitting/receiving means 120. However, the processing means 110 can access the memory via the system bus 118, accessing program code to instruct it what steps to perform and also to access the data. The processing means 110 then processes the data as outlined by the program code.

The memory 114 is used to hold instructions that are being executed, such as program code, etc., and contains a program storage portion 150 allocated to program storage. The program storage portion 150 is used to hold program code that can be used to cause the processing means 110 to perform predetermined actions.

The memory 114 also comprises a data storage portion 152 allocated to holding data and in embodiments of the present disclosure in particular provides a client preference storage means 202, image storage means 204, customer information storage means 206 and a selected item storage means 208. The function of these will be expanded upon hereinafter.

In this embodiment, the program code stored in the program storage portion 150 includes a template generation means 220, data retrieval means 222, an information query means 224, an item matching means 226, a saliency mapping means 228, a focus point detection means 230, a saliency/importance assessment means 232, and a document adjustment means 234. Again, the function of these will be expanded upon hereinafter.

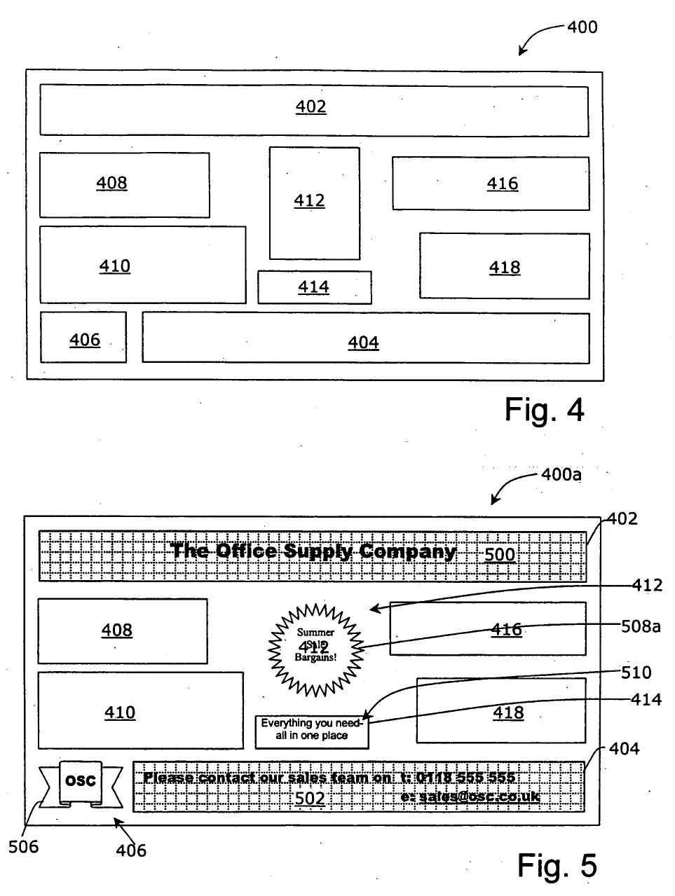

In the example now described, the computer 100 is used by a user to develop a draft document. In this example, a one-page advertising flyer is shown, on which three types of information are shown: images, price lists and descriptive passages. The flyer is produced (by a printer, or the like) for a predetermined customer of a client (in the example of the figures, the customer is a company called “The Office Supply Company”). Both the customer's requirements and the client's requirements are considered when producing the flyer. A template 400 for this document is shown for one embodiment in FIG. 4 and subsequent FIGS. 5 to 7 show how the template 400 develops into a draft document then into a finished flyer, for one embodiment.

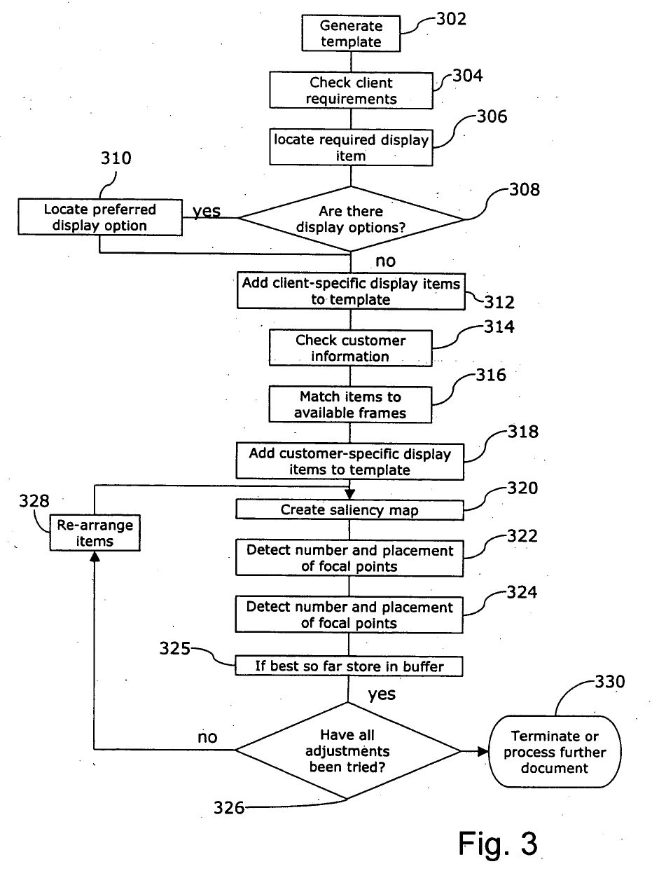

FIG. 3 shows a flow chart outlining the steps involved in carrying out one embodiment of the present disclosure. The first step 300 of the process is to provide a template 400 as shown in FIG. 4.

The document template 400 shown in FIG. 4 has been provided by the template generation means 220 such that it contains a number of containers 402 to 418. Each of these containers 402 to 418 is arranged to be filled with one or more data items stored in the data storage portion 152 of the memory 114. The template 400 may have been generated in several ways as will be appreciated by the skilled person.

Once the template has been generated, the computer 100 accesses the client preference storage means 202 in step 302.

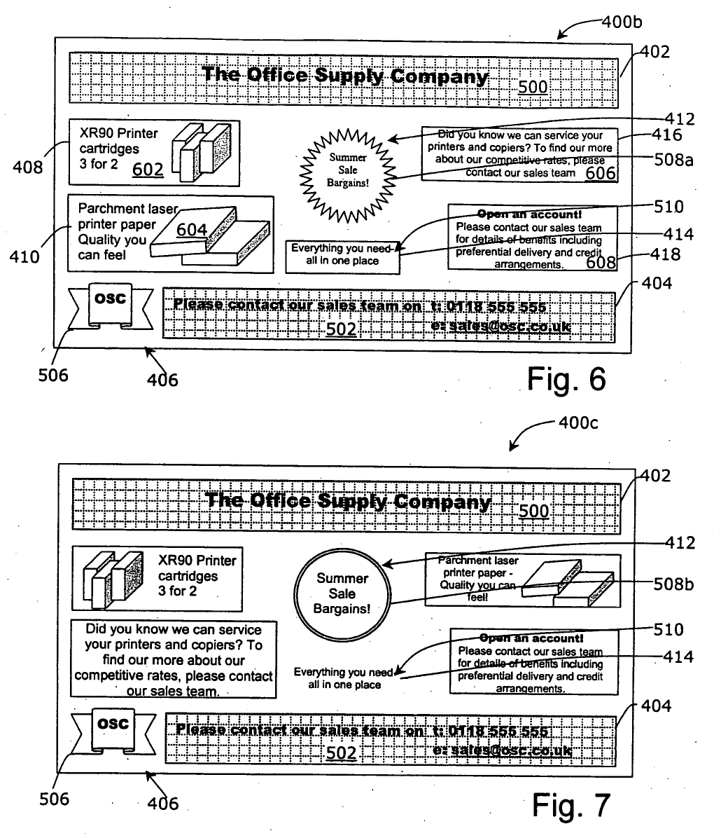

Details are added to the template 400 to create a first draft flyer 400b (which in this embodiment provides a draft document) as shown in FIG. 6 which fulfils conditions required by the client but which may not be as visually appealing as is required.

As will be appreciated from the ensuing description, the template generation means 220 in conjunction with the data retrieval means 222 and the item matching means 226 may be considered a document generation means.

The client preference storage means 202 comprises both presentation requirements and presentation preferences of the client. As a first stage, the data required by the client is added to the template; FIG. 5 shows a modified template 400a with the client-required data added.

In this example, the client requires each flyer, to have the company name 500 across the container 402 at a top region of the flyer. Further, in the container 404 across a bottom region of the page, the flyer has the contact details 502 for the sales team and in the container 406 in the bottom left hand corner region, the company logo 504 should be shown. These items are stored in the image storage means 204 which comprises a store of data items, and are located in step 306 then retrieved by the data retrieval means 222 and applied to the template 400 in step 312. Their size, colour and other aspects of their appearance are set by the client and cannot be altered by the method described below. As can be seen from FIG. 5, a container itself may not be visible on the flyer (the container 406 which contains the logo 506 is, for example, not shown).

In this example, the client also requires that a notice of the summer sale 508a, 508b and the client's slogan 510 are shown in specified central containers 412 and 414 respectively. These may be displayed in various ways which are considered in step 308. Considering the sales notice 508a, 508b, this has a preferred high impact format 508a and a second low impact format 508b. The relevance of the low impact format 508b is discussed later, however, it is the high impact format 508a which is located in step 510 and is applied to the template 400 in step 312 in generating a first draft flyer 400b.

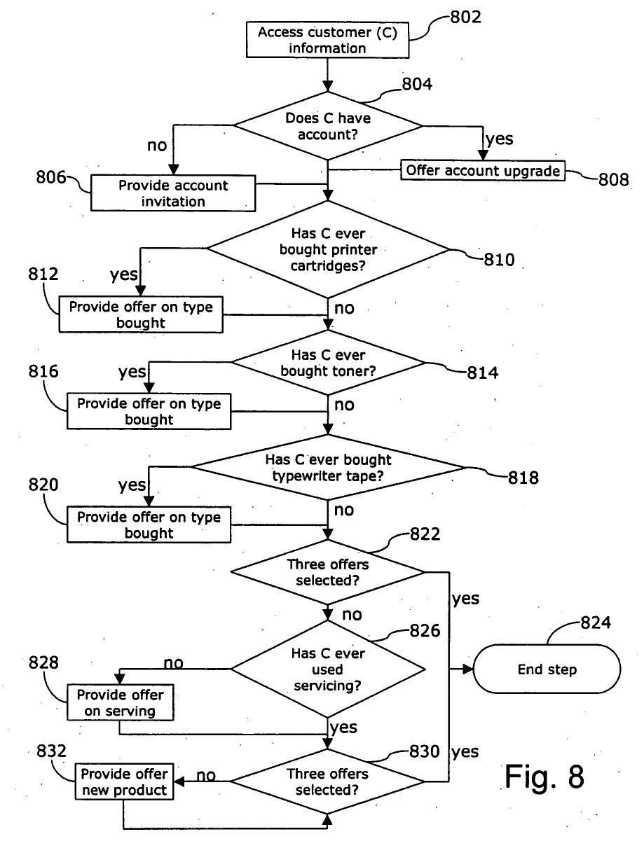

The next step 314 is to consider how to target the customer of the client. In this example, arbitrary choices are made to demonstrate the method but is should be appreciated that alternative choices could be made or alternative criteria applied. The selection method is shown in the flowchart of FIG. 8. Once an offer or other item has been selected, it is added to selected item storage means 208 of the data storage portion 152 of the memory 114. Each item has associated therewith relevancy data, which is stored in the relevancy data storage means 210. The function of this is described fully below but it provides an indication of how important the item is on the flyer.

In step 802, the computer accesses the customer information stored in the customer information storage means 206. This information is then queried using the information query means 224 in steps 804 to 822. First, the information is queried to determine whether the customer holds an account with the client (step 804). If not, an invitation to open an account should be provided on the flyer (step 806). If the customer does have an account, an account upgrade should be offered (step 808). Next, the information is queried to determine whether the customer has ever bought printer cartridges from the client (step 810). If so, the type of cartridge bought is found and information identifying the data item providing information on that printer cartridge is added selected item storage means 208, (Step 812). Then the customer information is queried to discover whether the customer has ever bought toner from the client (step 814). If so, the type of toner bought is found and information identifying the data item describing that type is added selected item storage means 208 (Step 816); if not, the next query is run. Finally, the customer information is queried to determine whether the customer has ever bought typewriter tape from the client (step 818). If so, the size of typewriter tape bought is found and information identifying the data item describing that size of tape is added selected item storage means 208 (Step 820).

There is then a check to see if all three offers have been selected (step 822) as, if they have, there will be no room for anything else on the flyer and the selection method should end (step 824). However, if all three have not been selected, a further query of the customer information is made to determine whether the customer has ever used the client's servicing facilities (step 826). If not, an advertisement for the facility should be provided. (Step 828). If the customer uses the facility already, or there are still less than three offers selected (step 830), a new product or products may be offered as step 832 until three offers are selected for the flyer. The selection process then terminates in step 824.

In the present example, the customer does not hold an account and an invitation should be provided to open an account. The customer has never bought typewriter ribbon or toner so these products should not be offered (on the assumption that the customer does not have machines which require these products). However, the customer has bought printer cartridges for an RW90 printer and therefore an offer on those cartridges should be provided. The customer has never used the client to service their machines so information to advertise this service should be provided. Finally, as there is space for a further offer, a new product is offered speculatively, in this case parchment paper for printers.

The next step, step 316, is to fit the selected items into the available containers. This may be achieved in a number of ways. For example, there could be one version of the data item stored and this could be scaled up or down in size. However, in this example, there are several versions of each data item stored and/or several options for display of a data item.

Some data items will comprise a picture of the item for sale and a description of the item or details of the price, etc. Such a data item may have the following example display options: Text to right of picture; text to left of picture; text above picture; text below picture; picture without text; text without picture; picture with short text; etc. It will be readily appreciated that, if the data item were to be displayed in a container which is in the form of a column (i.e. extending further down the page than across the page), it may be preferable to display the picture above or below the text. If the container is in the form of a row (i.e. extends further across the page than down the page), it may be preferable to have the text to one side of the picture.

It will be further appreciated that the data items need to be matched to the empty containers in step 316. This is done using the item matching means 226 which comprises program code stored in the program storage portion 150 of the memory 114. The skilled person will appreciate how such a program may function, but for the purposes of this example, the item matching means 226 places an item stored in the selected item storage means 208 into a container in which it fits, then fill up each container in turn so far as this is possible. If all the items are allocated to containers, then the process stops; otherwise, the item matching means 226 tries an alternative solution until all the items may be allocated. In some embodiments, it may be impossible to fit all the items, and different items may have to be selected. However, this possibility is not considered in detail here. Once all the items from the selected items storage means have been allocated to containers, the items are located in the image storage means 204 and are applied to the template 400 in step 318.

This is illustrated in the first draft flyer 400b shown in FIG. 6. In this flyer, a data item showing the printer cartridges (the cartridge data item 602) is shown in the container 408 in the top left hand corner region of the flyer 400b. The parchment paper data item 604 is shown in the container 410 in the bottom left hand corner region. The servicing facility data item 606 is shown in the top right hand corner container 416 and the account opening data item 608 is in the bottom right hand container 418.

The next stage in the process is to generate a saliency map using the saliency mapping means 228 stored in the program storage portion 150.

The skilled person will appreciate that the term ‘saliency map’ in this context is intended to refer to a map produced from an image to show where a human eye is most likely to look first. The degree of emphasis attributed to a graphic item is determined by several factors-graphics are more salient than text, coloured areas more salient than black and white, irregular shapes more salient than regular shapes, items with borders more salient that items without, etc. Other factors such as colour contrast, size, position on the page, depth of colour and so on also affect the saliency of an item. A saliency map may be thought of as an observer model and shows what the likely focus point of an observer of a document will be. Further, it can be hypothesised that the observer's eye will move from the most salient feature, or region, to the second most salient region, and so on. It should further be appreciated that the actual focus points may vary from person to person; this simply provides information about what is likely to occur in the majority of cases.

There are several known methods for creating saliency maps which rates regions of a document based according to the saliency of a region. Generally, the method operates on an image corresponding to the draft document. The Itti-Koch method, described fully in as detailed in Laurent Itti, Christof Koch, and Ernst Niebur, A model of saliency-based visual attention for rapid scene analysis (IEEE Transactions on Pattern Analysis and Machine Intelligence, 20(11):1254-1259, 1998), is one such method and is a ‘bottom-up’ method based on biologically plausible principles.

This method as is used in one embodiment of the present disclosure is now briefly described. The method indicates what may be salient in an image at a low level, assigning a saliency value to each pixel of an image corresponding to a draft document being processed. The method comprises deriving a saliency-grouping field, which is a vector field indicating, at each salient location and in various directions, the probability of having other salient locations associated to it. After calculating the saliency, the maxima of the map are retained as features. Then an initial grouping field is calculated by convolving the salient locations with the orientation-selective grouping kernels. The field is then iteratively reinforced at locations where a particular grouping direction stands out from others while also being consistent with neighbors in that direction.

The method works by first determining three image-topic maps, or channels, the intensity channel \overline{I}, the color channel \overline{C} and the orientation channel \overline{O}. A normalization operator N(·) that emphasizes maps with few, strong conspicuous locations is the applied to each channel and the saliency map is simply computed as

$$S = \frac{1}{3} ( N ( \overline{I} ) + N ( \overline{C} ) + N ( \overline{O} ) ) .$$

Each of the three channels \overline{I}, \overline{C} and \overline{O} is computed by combining center-surround responses across different spatial scales by first emphasizing maps with conspicuous location by using the normalization operator N(·) and summing them using “across-scale” addition ⊕, where all the maps at different spatial scales are mapped onto a single, intermediate spatial scale. Center-surround differences are computed by point-to-point “across-scale” differences Θ at two different scales, one, coarser, for the surround and another, finer, for the center. For instance, if I(c, s) is a center-surround intensity map for a particular c (center) and s (surround) scales, then we have \overline{I}=⊕_{c}⊕ₛ N(|I(c)ΘI(s|) where the ”across” scale sum is extended at several surround and center scales, with s>c (0 is the finer scale).

Individual maps are recovered as follows.

The intensity maps are I(c, s)=|I(c)ΘI(S)| where I(k) is the intensity of the image at spatial scale k; it represents intensity contrast, scoring highly when something is brighter than its surroundings. The color maps C(c; s) are based on the “color opponent” theory which combines two contrast maps expressing the contrast between red/green in the surround and green/red in the center in the following expressions where R, G, B and Y indicate the red, green, blue and yellow components of an image. RG(c, s)=|(R(c)−G(C))Θ(G(c)−R(c))|, and blue/yellow and yellow/blue BY(c, s)=|(B(C)−Y(c))Θ(Y(c)−B(C))| into a single map using the normalization operator, that is C(c,s)=N(RG(c,s))+N(BY(c,s)).

The orientation maps are computed for four different orientations θₙ and an orientation map is given by O(c, s, θₙ)=|O(c, θₙ)Θ O(s; θₙ)|. Each O(k; α) is the result of applying a Gabor filter with orientation a and at the image scale k. As the skilled person will appreciate, a Gabor filter is an orientation filter which responds according to the orientation of a part of an image. The final map O is computed by also summing responses for the four angles, along with across various center and surround scales.

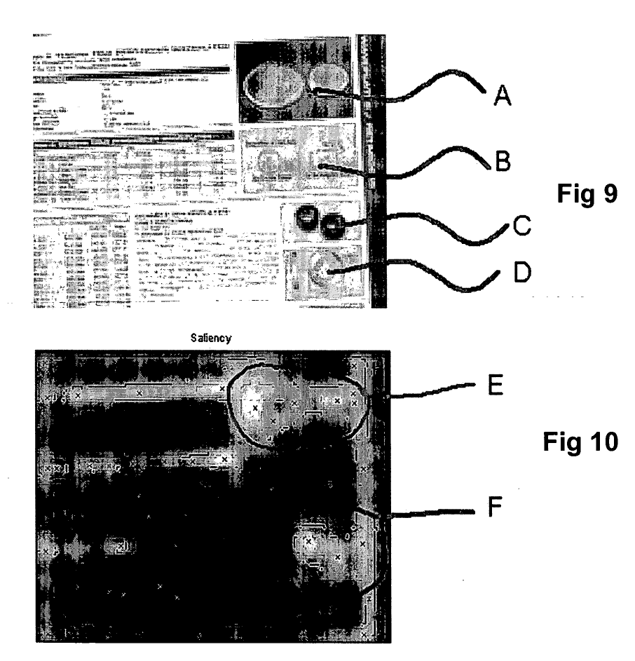

An example of a document and the saliency map generated therefrom are shown in FIGS. 9 and 10 respectively. The document displays four highlighted data items A-D. The saliency map shows white for areas having a higher saliency than other areas. It can be seen in the example salient points are found at E and F and the position of these points E, F correspond with the data items A and C respectively. The data items B and D are less salient.

It will be appreciated that when creating documents, it is desirable to ensure that the most important items are the most salient. However, this should not be at the expense of ensuring the document is attractive and interesting. As a skilled designer would understand, a ‘successful’ design will have more than one focus point, but too many can cause confusion. Having more than one focus point encourages the eye to move around the page. Therefore, focus points should not be placed too close to each other. Further, the document's layout can be used to give emphasis important items and de-emphasize the less important.

Under the present example, the image of the first draft flyer is provided as an input to saliency mapping means 228 as step 320. This is then to be examined by the focus point detection means 230 in step 322 to determine the number and placement of focus points. In this example, the flyer is judged according to the following rules:
1. There should be two or three focus points; and
2. The focus points should be a minimum of 20 cm apart.

If either of these conditions is broken, the first draft flyer is rejected and a second draft (which in this embodiment provides an adjusted document) flyer is created. The skilled person will appreciate that there may be more or less rules than are provided in this example or the rules may be different.

The saliency map is then further interpreted by the saliency/importance rating means 232 in step 324 with reference to relevancy data from the relevancy data storage means 210. It will therefore be appreciated that the saliency/importance rating means 232 and the focus point detection means 220 comprise a saliency retaining means. In this example, of the selected items, the relevancy has been judged as being between 1 and 3, with 1 being the most relevant. The client's name 500, contact details 502 and logo are level 1, the concerning opening account and the printer cartridges are level 2, and the information concerning the parchment paper, the summer sale and using the servicing facilities is level 3. It will be appreciated that this scoring arrangement is an example only and any suitable scoring mechanism may be used.

In the embodiment being described, this leads to rule 3: At least a predetermined score must be calculated by the saliency/importance rating means 232.

From the foregoing description it will be appreciated that so far, items have been matched with available containers, but no consideration has been given to their relevance. Further, there may be more- perhaps many more- ways the items could be arranged within the containers. The items may therefore be ‘shuffled’ or a different display option selected in order that the most important items are made to be the most salient. For example, a border may be added or a contrasting background colour may be added to try and improve the saliency of an item.

Under the present example, the saliency/importance rating means 232 is arranged to register the focus points with the position of the containers. This is to say that a data item will not itself be identified as emphasized. Instead, the container which holds it will be identified as emphasized. It may therefore be determined if the content of the container should be moved or if an item should be altered within the container. The first draft flyer 400b may then be scored according to how well the content of the emphasized containers match the important items. For example, if an item with a relevance rating of 1 at in a focus point, 4 may be added to the score. If an item with relevance rating of 3 is at a focus point, 3 may be taken away from the score, and so on. It will be appreciated that relevancy and saliency are not synonymous; the content of a container may have a high relevancy (i.e. it is important) but it may actually have a low saliency (i.e. it does not stand out on the page). Embodiments of the present disclosure may be used to address this to ensure that the content of containers having a high relevancy also has a high saliency.

Under the present example, salient pixels shown as white and non-salient pixels as black. Where a cluster of salient pixels is shown, a salient area may be identified. This is illustrated in the illustrative saliency map of FIG. 6a corresponding to the draft flyer of FIG. 6. It should be understood that the saliency maps of FIGS. 6a and 7a are illustrative only and have not been mathematically produced from FIGS. 6 and 7. A saliency map created using an embodiment of a method based on the Itti-Koch method is shown in FIG. 10.

In FIG. 6, it can be seen that there are two images which are closely grouped and which are also near the sale notice 508a, which has an irregularly shaped border and is therefore reasonably salient. This will create a focus point around these three items on the left hand side of the first draft flyer 400b. This is shown as an area of the saliency map in FIG. 6a as a cluster of white pixels 650. A further salient point 620 is seen about the logo at the bottom left hand corner region. Therefore, there are two salient points, which is acceptable to the client under the first rule but they are less than 20 cm apart, so do not encourage the eye to move around the flyer and violate the second rule. Finally, the information concerning the parchment paper and the summer sale, which have a low importance are among the most salient features—this breaks the third rule. Thus, the layout of the items should be improved so that the rules are not broken.

The next stage to consider is the course of action to be taken when the flyer is rejected, perhaps due to too many or too few focus points, focus points being too close together or having a low score from the saliency/importance rating means 232.

It will be appreciated that most items have a set of adjustable parameters. Even if there is only one display arrangement provided, the colours may be altered. A set of adjustable parameters may be selected according to client preferences. Some of the items may not have any adjustable parameters for example, it is likely that there will be no alternative colours for the company logo 506. In addition, each item may have at least one parameter fixed—such as the aspect ration of an image or the size of font for a passage of text.

An amended document, in this case a second or subsequent draft flyer can be created by using the document adjustment means 234, adjusting the adjustable parameters in order to improve the aesthetic qualities of the document in step 328. An example of a second draft flyer 400c is shown in FIG. 7.

Under the present example, there is a feed back loop and the image of the second draft flyer is provided as an input to saliency mapping means 228 as step 320, which produces a saliency map which is then investigated as before.

In this example, the second draft is more suitable. The saliency map produced from the flyer is shown in FIG. 7a. The flyer has been amended as follows: The irregular border about the sale item 508a has been replace with a line—this is the low impact format 508b for this item. The graphics in the cartridge item 602 and the parchment paper item 604 have been separated and are now either side of the centre point. The text and the graphic in the cartridge item 602 have swapped position to make the document more symmetrical and the size of the parchment paper item 604 has been reduced as the container it has moved to is smaller than the previous container. There are three main salient points, 750, 752 and 754 dispersed substantially in a horizontal line across the flyer. As there are three points, rule one is not broken. Further, the points are sufficiently dispersed not to break the second rule. Finally, the less important parchment paper item is now less salient than the information relating to printer cartridges (i.e. there is less white in that area). This means that the salient points match up better with the areas rated as important and the second draft flyer meets the requirements of the third rule.

The score of this second draft flyer is compared with the scores from the previous draft. If the score is higher then the second draft flyer is stored in a buffer 212 and the score recorded as the highest (step 325). This may be a preferred feature as only the best example of a document is stored, thereby saving memory space.

It should be appreciated producing a flyer in its entirety may be a computationally intensive operation. Therefore, for the second draft (adjusted documents) and subsequently generated flyers reusability issues may be considered at this stage in an attempt to reduce the amount of processing that is performed. For example, only items whose attributes have changed may be created and correspondent areas of previously flyer stored and retrieved in order to overlap with the later generation. The other possibility is to associate items that have been created with different containers on a flyer, so when items are for example moved, the correspondent containers are not recomputed, but rather placed on different positions. In perhaps a preferred embodiment, the saliency map is not computed from the second draft flyer in the same way as described above in relation to the first draft flyer. Instead, parts of the previous saliency map may be reused. The ‘peaks’ shown as salient points 650, 652 in the saliency map produced from the first draft flyer could be moved to the new location of the item which was found to produce the point.

The second draft flyer may be created in several ways. If the most relevant items are not emphasized, i.e. are not likely to be the first to attract attention as indicated by the saliency map, their contrast with neighbouring elements may be enforced, they may be enlarged, etc. Otherwise, intensity of least relevant items may be decreased. However, if the there is relevancy match, but focus points are too close to each other, the attempt to shift underlining items farther apart may be considered or alternative layout with these elements positioned in different containers, for example.

The method of the current embodiment continues to loop until possible adjustments to the flyer have been considered. Once the looping has terminated the flyer stored in the buffer 212 is taken to be the flyer that should be used for that customer. If there are further customers for whom a flyer is required then the process can be restarted.

The skilled person will appreciate that many further drafts of flyers could be produced. An advantage of the method is that it provides a feedback loop in developing a document. This may enable a document to be visually improved without the need for input from a document designer. The method may continue until all possibilities have been exhausted as described above, or may terminate (step 330) when a saliency map which scores above a threshold amount it scored. Alternatively, a number of versions could be created and the highest scoring version chosen. Finally, if no satisfactory documents are found then a new template could be created or sourced and the processes started again.

Some variations on the above description which do not depart from the scope of the present disclosure are now considered. First, the process may not be iterative though generations. Instead, amendments may always be made to the first draft flyer, for example.

Therefore, having thus described the invention, at least the following is claimed:

1. A method of creating a document comprising the following steps:
generating a draft document and creating a saliency map therefrom which rates regions of the draft document according to the saliency of that region;
performing a comparison of the saliency of one or more predetermined regions against a relevancy rating for that region; and
altering one or more document parameters associated with the draft document if the comparison shows that one or more of the predetermined regions has a saliency that does not match that required by the relevancy data for that region.

2. The method according to claim 1 in which the method alters one or more parameters in order to increase or decrease the saliency of a region.

3. The method according to claim 1 in which an adjusted document is created by altering the parameters of the draft document and the adjusted document is evaluated as if it were the draft document.

4. The method according to claim 3 which comprises performing the method until any of the following occur:
the document parameters have been substantially exhaustively altered;
a predetermined number of adjusted documents have been processed by the method;
the adjusted document achieves a predetermined rating from the comparison.

5. The method according to claim 1 in which one or more predetermined rules are used to determine which document parameter is altered.

6. The method according to claim 1 in which the document parameter relates to any one or more of the following:
the presence of a border associated with one or more of the regions;
the colour of at least a portion of a region;
the size of one or more of the regions;
the orientation of one or more of the regions;
the style of a border applied to one or more of the regions;
the shape of one or more of the regions;
the relative position of one or more regions or portions thereof.

7. The method according to claim 1 in which the saliency map is created by assigning a saliency value to a region of an image representing the draft document.

8. The method according to claim 7 which comprises weighting saliency values according to their distance from a predetermined location on the draft document.

9. The method according to claim 1 which comprises generating the saliency map by generating at least one of an intensity saliency map, a colour saliency map and an orientation saliency map and combining the so generated maps to generate the saliency map.

10. The method according to claim 9 which comprises generating the intensity saliency map, colour saliency map and/or orientation saliency map using a centre surround method.

11. The method according to claim 1 in which the saliency map is generated according to the Itti-Koch method.

12. The method according to claim 1 which comprises determining salient regions using non-maxima suppression of the saliency map.

13. A document creation system comprising:
a saliency mapping means arranged to receive an electronic version of a document displaying content and to determine salient regions of the document;
a saliency rating means arranged to give a rating of the document according to the salient regions determined by the saliency mapping means; and
a document adjustment means arranged to adjust the content of a document and to generate an adjusted document in which the rating given by the saliency rating means more closely matches a predetermined desired rating.

14. A system according to claim 13 which is arranged to take the adjusted document as the document for assessment and to further arranged to assess the adjusted document to give a rating from saliency rating means for the adjusted document.

15. A system according to claim 13 in which the document adjustment means is arranged to adjust the document using one or more predetermined rules.

16. A system according to claim 13 in which the document adjustment means is arranged to adjust at least one parameter associated with the layout of the content.

17. A system according to claim 16 in which the document adjustment means is arranged to adjust the document in one or more of the following ways:
rearranging the content displayed on the document;
replacing at least part of the content of the document; and
changing the appearance of all or part of the content of the document by adding a border, adjusting one or more colours, changing the shape, size, orientation, font.

18. A system according to claim 16 in which the system is arranged to process adjusted documents until any of the following:
adjustments to parameters have been substantially exhaustively made;
an adjusted document is produced that is judged to be satisfactory according to predetermined criteria; and
a predetermined number of adjusted documents has been produced.

19. A system according to claim 13 which is arranged to record the saliency rating for each adjusted document along with the adjusted document if the current adjusted document has a higher rating than the highest previously recorded saliency rating.

20. A system according to claim 13 in which the saliency mapping means is arranged to generate the saliency map by assigning a saliency value to a region of an image representing the draft document.

21. A system according to claim 20 in which the saliency rating means is arranged to weight saliency values of a pixel according to the pixel's distance from a predetermined location within the document.

22. A system according to claim 13 in which the saliency mapping means is arranged to generate at least one of an intensity saliency map which maps the intensity of pixels of an image representing the document, a colour saliency map which maps the colour of pixels of an image representing the document and an orientation saliency map which maps the orientation of pixels of an image representing the document and further arranged to combine the maps to generate a saliency map.

23. A system according to claim 22 which is arranged to generate the intensity saliency map, the colour saliency map and/or the orientation saliency map using a centre surround method.

24. A system according to claim 23 in which the saliency mapping means is arranged to determine salient locations by non-maxima suppression of the saliency map.

25. A machine readable medium containing instructions to cause a computer to perform the method of claim 1.

26. A machine readable medium containing instructions to cause a computer to function as the system of claim 13.

27. A program arranged to cause the method of claim 1 to be performed.

28. A program arranged to cause a computer to function as the system according to claim 13.
